(19) United States
(12) Patent Application Publication
(10) Pub. No.: US 2026/0119704 A1
(43) Pub. Date: Apr. 30, 2026

(54) SMARTPHONE FORENSIC TOOL

(71) Applicant: HEXORDIA LLC, Bridgeport, NY (US)

(72) Inventors: Jessica Hyde, Bridgeport, NY (US); Nicholas Dubois, Rehoboth, MA (US)

(73) Assignee: HEXORDIA LLC, Bridgeport, NY (US)

(21) Appl. No.: 18/933,681

(22) Filed: Oct. 31, 2024

(51) Int. Cl. G06F 21/62; G06F 11/30

(52) U.S. Cl. CPC G06F 21/6245; G06F 11/3072

(57) ABSTRACT

Systems and methods are presented for retrieving data from a locked or otherwise restricted smartphone or mobile device. Utilizing a stream of filters and parsers, the system and methods acquire forensic data from access points of the smartphone. Access points for data acquisition include the device's filesystem, backup services, diagnostic services, among others.

### FIELD OF THE INVENTION

This invention is directed to the field of digital forensics. In particular, forensic data acquisition from locked or otherwise restricted mobile devices.

### BACKGROUND

In the fields of digital forensics and incident response, acquiring data from a locked or otherwise restricted mobile device is at best challenging and at worst impossible. Conventional data acquisition tools and methods often require either possession of the device passcode or an exploit. Even with these methods, acquisition of the full file system may only be possible with exploits gaining super user permissions, leaving only logical (using a passcode) or limited logical (without a passcode) acquisition possible under average user permissions. As exploits gaining full file systems require a jailbreak or commercial exploits typically limited to certain law enforcement agencies and an exploit may only work on a specific combination of hardware and operating system version and likely will be fixed a will not work with future operating system versions, a system is needed to acquire data in a comprehensive and meaningful manner.

Even with a passcode provided, a full file system acquisition may not be possible, and forensic examiners may not be able to read sensitive system files, or root user files. With newer devices running current operating systems, a physical acquisition of iOS devices is not currently possible. Full file system and limited filesystem acquisition may be feasible with exploits. However, these exploits are often only be available to law enforcement agencies and may require the passcode to the device.

Memory acquisition can be a useful way to access data from a locked mobile device, however is often regarded as difficult to work with. Userspace memory can be difficult to obtain and is limited in contents and readability. Kernelspace memory may be regarded as useless for digital forensics as it is primarily read only. Thus, memory acquisition may be difficult to work with and not useful.

Logical data acquisition provides a feasible and easy to work with a dataset without the use of jailbreaking or other exploits. System log files can contain a wealth of information useful to forensic examiners and be available through a logical file acquisition. Logical log acquisition allows for access to important information for forensic examiners as well as real-time monitoring which can be used for testing hypotheses. Thus, there is a need for a system that is able to conduct a logical log acquisition and provide an easily readable and meaningful dataset.

### SUMMARY

Systems and methods for obtaining forensic data from a mobile device are described herein.

In an exemplary embodiment, a method for obtaining forensic data from a smartphone begins by connecting a smartphone to a desktop computer via a wired connection. The method determines if trust has been established between the smartphone and the desktop computer. If trust has been established, the method monitors the system log of the smartphone to create a system log output. The system log output is filtered to create a filtered system log output, and the system log output is communicated to a user interface.

In an exemplary embodiment, the method further includes receiving device information from the smartphone. The device information is filtered to create filtered device information, and the filtered device information is communicated to the user interface.

In an exemplary embodiment, the method further includes monitoring the diagnostic relay service of the smartphone to create a diagnostic relay service log. The diagnostic relay service log is filtered to create a filtered diagnostic relay service log, which is communicated to a findings user interface.

In an exemplary embodiment, the method further includes monitoring the device's backup service to create a device backup log. The device backup log is filtered to create a filtered device backup log, and the filtered device backup log is communicated to the user interface.

In an exemplary embodiment, the method further includes monitoring a smartphone file conduit and obtaining a user filesystem from the file conduit. The user filesystem is filtered to create a filtered user filesystem, and the filtered user filesystem is communicated to the user interface.

In an exemplary embodiment, a system for obtaining forensic data from a smartphone includes a system log monitor. The system log monitor receives the system log of the smartphone. The system also includes a filter, and a user interface.

In an exemplary embodiment, the system also includes a raw output user interface. The raw output system interface receives data from the diagnostic relay service of the smartphone. A findings user interface receives data from the diagnostic relay service.

In an exemplary embodiment, the system also includes a device information user interface.

In an exemplary embodiment, the system also includes a user filesystem that receives data from the smartphone's file conduit.

In an exemplary embodiment, the system also includes a device backup log. The device backup log receives data from the smartphone's backup service.

### BRIEF DESCRIPTION OF THE DRAWINGS

FIG. 1 illustrates an exemplary system for retrieving forensic data from a smartphone;

FIG. 2 illustrates an exemplary system for retrieving forensic data from a smartphone;

FIG. 3 illustrates an exemplary system for retrieving forensic data from a smartphone;

FIG. 4 illustrates an exemplary method for retrieving forensic data from a smartphone;

FIG. 5 illustrates an exemplary method for retrieving forensic data from a smartphone; and

FIG. 6 illustrates an exemplary method for retrieving forensic data from a smartphone.

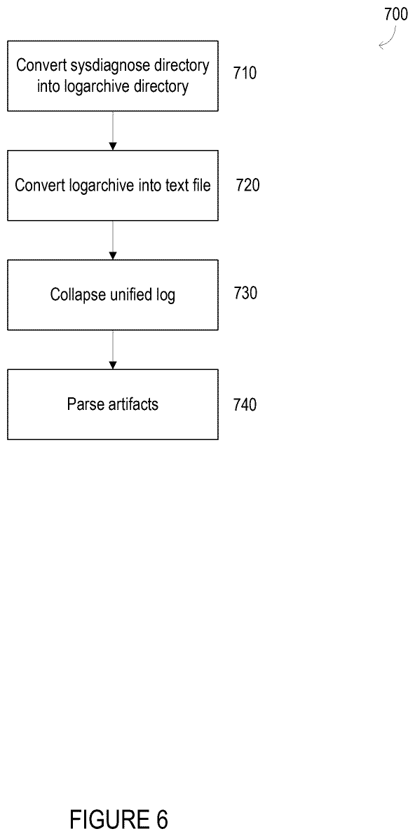

### DETAILED DESCRIPTION

Logical acquisition of data from a locked or otherwise restricted device provides forensic examiners with an easy to work with dataset and is possible without jailbreaking.

While various systems and modules described pertain to Apple devices by Apple, Inc. of Cupertino, California, other operating systems such as Android and Windows may also be examined through analogous systems as are well known in the art.

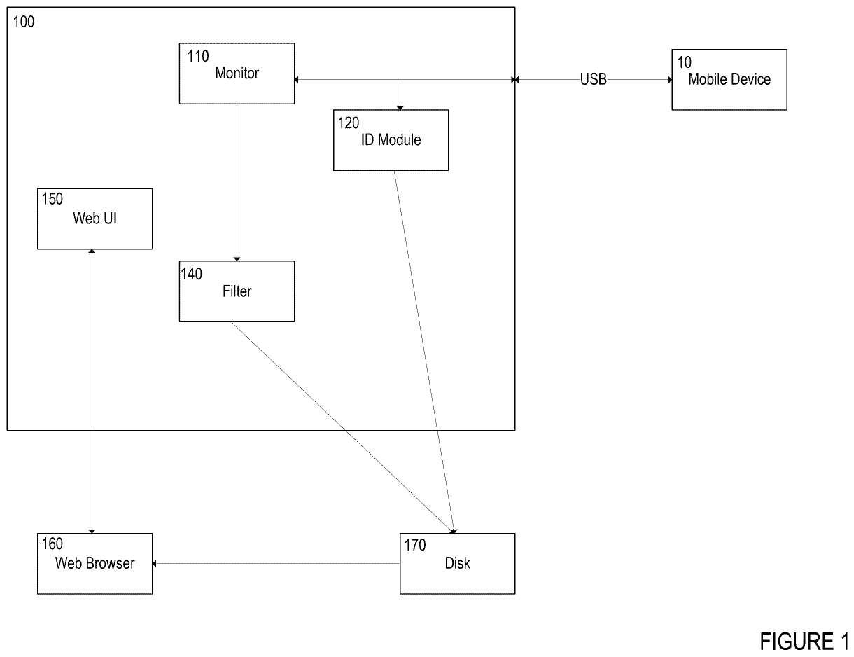

With reference to FIG. 1, an exemplary system for conducting the most basic logical data acquisition is demonstrated in which the system will gather only identification information from the phone, such as its IMEI and OS version. A mobile device 10 is connected to the data acquisition system 100 on a desktop device by USB (universal serial bus). Generally, the system 100 includes a monitor 110 that real-time monitors and reads logs and other data systems on the mobile device 10. The system also includes an ID module 120 that retrieves device 10 information.

Data accessed by the monitor 110 is communicated to the filter 140. The filter 140 parses the data to highlight areas of interest to the examiner and convert the data into an easier format to read.

The ID module 120 and filter 140 communicate with the disk 170 of the desktop device which in turn communicates the data to a web browser 160 for presentation to the examiner. The web browser 160 is also in communication with a web user interface (UI) 150 within the system 100 itself. Both the web UI 150 and web browser 160 may be used to present forensic data to the examiner.

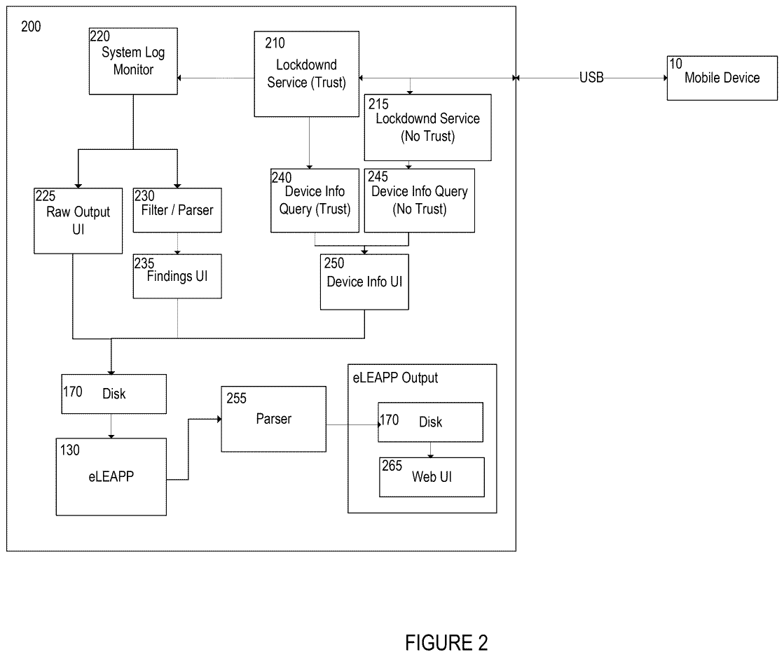

FIG. 2 illustrates an exemplary system 200 for retrieving forensic data which includes device information as well as stream of live log data from a mobile device 10. The illustrated system 200 of FIG. 2 may be considered a light system, suitable for testing the what forensic artifacts appear in the log files when certain events occur or actions are taken, teaching about how to test and validate data, as well as free-to-access software for basic data acquisition.

A mobile device 10 is connected to the system 200 by a USB connection. The system 200 then queries if the lockdownd service is in a trust 210 or no trust 215 state. If the device 10 is in a no trust 215 state, a device info query 245 is run and device information is acquired. Device information acquired at this stage may include MAC address and device name among other hardware and operating system (OS) information.

If the lockdownd service is in a trust state 210, the system 200 also runs a device info query 240 to determine device information. In either case, both no trust 245 and trust 240 device information queries communicate information to the device information UI 250.

In the case that trust 210 is established, the system monitor log 220 reads device 10 data in real-time. Data read by the system monitor log may include sysdiagnose logs, live syslogs, and other activity information of the device 10 produced in real-time.

Data from the system log monitor 220 is communicated to the raw output UI 225 and the filter/parser 230 of the system 200. The raw output UI 225 transmits data through the system 200 for the option for display in its raw form without filtering or presentation in a more user-friendly format.

The filter/parser 230 is configured to highlight data of interest for examiners and parse the information into an easier to read format than the raw data log. Irrelevant data may be removed by the filter 230 before being communicated to the next stage of the system 200.

The filter/parser 230 communicates data to the findings UI 235 for the option for presentation before further processing.

The raw output UI 225, findings UI 235, and device info UI 250 communicate data to the eLEAPP platform 130 via Disk 170. As stated previously, while LEAPP-based platforms are preferred, any similar platform may be used as is known in the art.

The eLEAPP module 130 reads system log files that were acquired by the previous modules and has parsers that have a detailed understanding of potentially useful evidence that may exist in these files. It parses the files to extract the information and converts it into a common format, for example representing all time stamps, GPS coordinates, and phone numbers each in a uniform fashion. Then it creates output formatted in a way that is useful for investigators, for example searchable HTML tables grouping each set of data in a table where each table has a standard form (such as time, general information, specific information) where the tables can be searched by any column and sorted in increasing or decreasing order by that column. The eLEAPP 130 module is used for more flexible processing that can correlate data from different sources or log files.

The eLEAPP platform 130 uses parsers 255 to process the data from the log files, which is an extensible collection of parsers, each of which parse and interpret the file format (such as plist and text) and message format specific to particular pieces of evidence (such as call records, GPS data, installation or deletion of an application program), and then produce tabular output in a standard format (e.g., tables in HTML) that can be displayed in a web browser

The parser 255 communicates the data as an eLEAPP output to the disk 170 of the desktop device in a format that can be displayed on a web browser (typically HTML, CSS, and Javascript) and subsequently to a web UI 265 for display to the examiner.

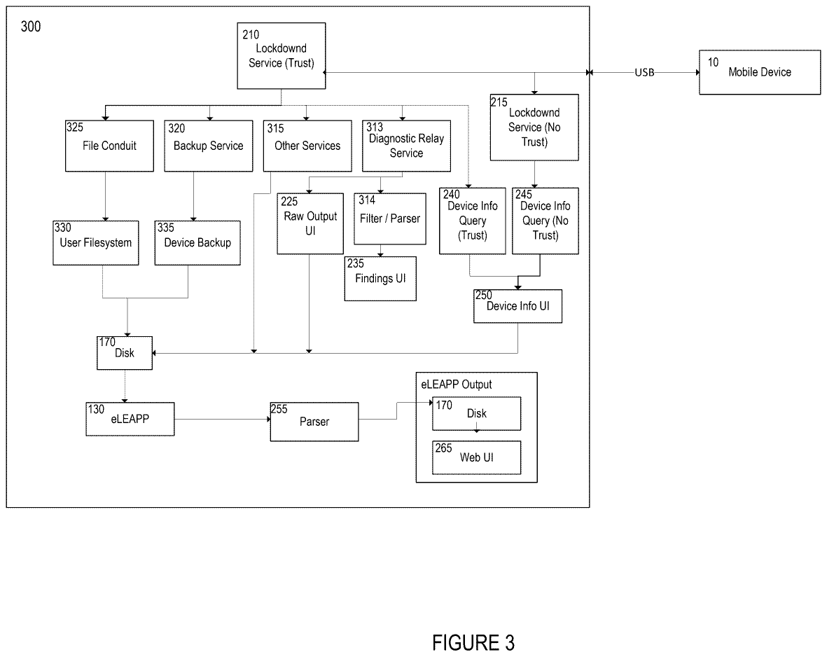

FIG. 3 illustrates an exemplary system 300 for retrieving and parsing forensic data from a mobile device 10, including historical log information. The system 300 of FIG. 3 may be suitable as a more extensive data retrieval than the system 200 of FIG. 2.

The mobile device 10 is connected to the system 300. As in the system 200 of FIG. 2, the system 300 queries if the lockdownd service is in a trust 210 or no trust 215 state. As with the system 200 of FIG. 2, the system 300 of FIG. 3 conducts a device info query 240, 245 in either state and delivers device information to the device info UI 250.

If the lockdownd service is in a trusted state 210, mobile device 10 data is monitored by the file conduit 325, backup service 320, diagnostic relay service 313, and other services 315. The file conduit 325 reads logs and produces a user filesystem 325. The backup service 320 reads and produces a log of device backups 335. The diagnostic relay service 313 produces a log of diagnostic data generated by the mobile device 10. The data generated by the diagnostic relay service 313 may be communicated to a raw output UI 225 for examination in its raw form. The diagnostic relay service 313 data is also communicated to a filter/parser 314 to have information of interested highlighted and/or filtered from the raw data and presented to the examiner in an easy to read format.

The user filesystem 330, device backup 335, diagnostic relay service raw output 225, and data retrieved from other services 315 are communicated to the disk 170 of the desktop machine along with the data from the device info UI 250. The disk 170 communicates the data to the eLEAPP platform 130.

From the eLEAPP platform 130 the data is communicated to a parsers 255.

Data from the parsers 225 is communicated as eLEAPP output to the disk 170 device in a format that can be displayed on a web browser (typically HTML, CSS, and Javascript) and ultimately to a web UI 265 for display to the examiner.

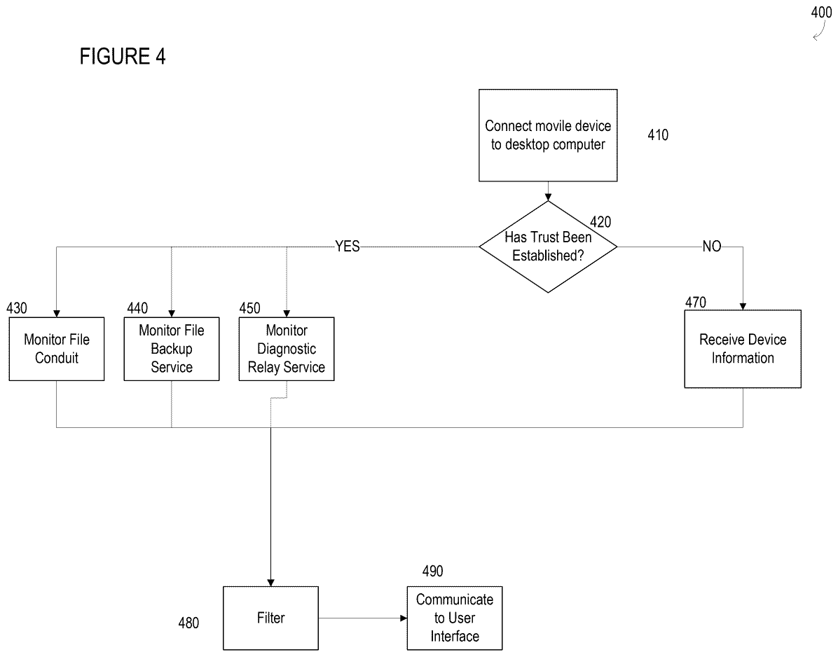

FIG. 4 illustrates a method 400 for extracting forensic data from a mobile device 10. The method 400 begins at step 410 by connecting a mobile device to a desktop computer, preferably by a USB connection. At step 420 the method 400 queries if trust has been established between the mobile device and the desktop machine. If trust has not been established, the method 400 proceeds to step 470 to retrieve device hardware and OS information.

If trust has been established, the method 400 proceeds from step 420 to steps 430, 440, and 450 simultaneously. At these steps, the method 400 monitors the file conduit 430, the file backup service 440, the diagnostic relay service 450, and the backup service 460, with functions as described above.

The data received from steps 430, 440, 450, and device information from step 470 is communicated to a filter 255 in step 480. The filter 255 highlights pertinent information for the examiner and presents the information in an easily readable format as described above. The method 400 ends at step 490 where the filtered data is presented to a user interface.

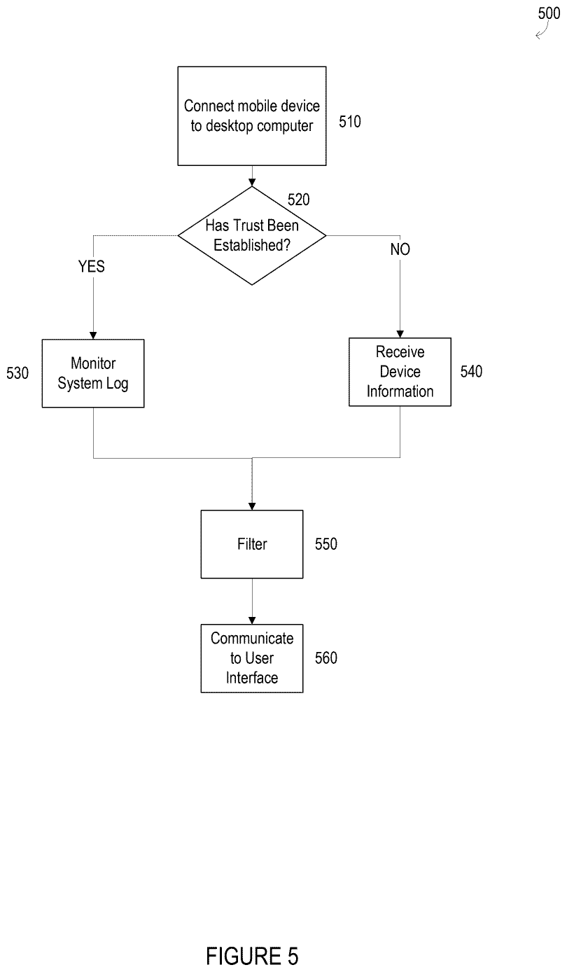

FIG. 5 illustrates a method 500 of extracting forensic data from a mobile device 10 suitable for light level extracts, for example in free-to-use software.

The method 500 begins at step 510 by connecting a mobile device to a desktop machine, preferably by USB connection. The method 500 continues to step 520 and queries if trust has been established between the mobile device and the desktop machine. If trust has been established, the method 500 proceeds to step 530 and monitors the system log, as described above. If trust has not been established, the method 500 proceeds from step 520 to step 540 and receives device information, including hardware and OS information as described above.

Regardless of if trust is established, both steps 530 and 540 proceed to step 550, communicating the extracted data to a filter 255 for processing as described above in greater detail. The filtered data is communicated to a user interface for review by an examiner in step 560.

A device that a forensic examiner may wish to retrieve data from may be in various states. The state of the device can determine how difficult data retrieval is and depends on factors such as if the device has been recently booted, if it has been unlocked since a boot, if the device has been updated, and others as described below.

Before first unlock (BFU) is the state of a device after the device reboots but before it is unlocked for the first time. Features in this state are very limited and the device is protected at a deeper level until it is unlocked.

After first unlock (AFU) is the state of the device after it has been unlocked at least once. Restrictions in place in BFU mode are largely lifted.

Recovery mode is a diagnostic mode typically used to recover from fatal booting errors or factory reset devices.

Device firmware upgrade (DFU) is a low-level bootrom communication tool for developers and device configurations used largely for flashing. The device may appear powered off in this state.

Diagnostics mode is a lesser-known mode used for diagnosing hardware issues. Users don't often see anything in this mode, as it is used by manufacturers. Not much can be achieved in this mode as an examiner, however some identifiers such as the serial number, mobile equipment identifier (MEID), and international mobile equipment identity (IMEI) of the device are available.

A trusted/paired state is required for most logical acquisitions of data. A device is not in a trusted/paired state immediately after a reboot, in SOS mode, or while in the inactive device state. When not in a trusted/paired state, the device will refuse to communicate with other devices over USB until “trusted”. This requires use of a passcode and physical connection to a PC and certifying trust of that device.

USB Restricted Mode (USB RM) is a state in which after a reboot, SOS mode, or inactive device state a device will refuse to communicate with other devices over USB. Devices may enter this state after a period of inactivity which varies from device to device and OS to OS. A way to prolong the window of inactivity and prevent USB RM is to utilize a dongle.

Depending on the state of the device, different data may be gathered. For example, a paired and locked device may recover: sysdiagnose logs, live syslogs, iTunes backups, Siri information, lockscreen widgets and info, RAW USB traffic data, recovery mode data, DFU mode data, diagnostics mode data, and APIs (e.g., iTunes account email address, first and last name, and additional generic iTunes account information).

An unpaired and locked device may recover: Siri information, lockscreen widgets and info, RAW USB traffic data, recovery mode data, DFU mode data, diagnostics mode data, remote Sysdiagnose logs, and APIs.

A device in diagnostics mode may recover: device serial number, MEID, IMEI, unique device identifier, Wi-Fi MAC address, hardware information, iOS version, baseband information, names of photos, and photo metadata (e.g. datetime and location).

A device in recovery mode may recover: device model, unique device identifier, current IMEI, generic device information, partial iCloud email address, if the device is iCloud locked.

The following details of types of log information types are listed as examples only, and are not meant to be exhaustive. Other forms of capturable information are possible to acquire with the detailed systems and methods.

Sysdiagnose log device information may detail: device name, iOS version, OS information, UUID, languages, time zones, keyboards, power on times, application run times, screenshot taken times, connected USB devices, device trust datetime logs, battery percentage, device orientation, charging status, screen status, brightness, and motion information.

Sysdiagnose application information may detail: installed applications, application versions, application permissions, currently running applications/processes, and application run times.

Sysdiagnose log Wi-Fi and Bluetooth information may detail: HW MAC address, private MACs, connected SSID, BSSID, country code, IP address, router IP address, DNS, Wi-Fi scanned networks, first joined times, last joined times, paired/connected Bluetooth devices, networks latitude/longitude locations, and external IP addresses and domains.

Sysdiagnose log user/cloud information may detail: full name, iCloud email, unique username identifiers, cloud sync timestamps, API keys, keychain info, and cloud container info.

Sysdiagnose nested logs may detail: Transparency Consent and Control (TCC) database, device settings and preferences, powerlog, application usage logs, application battery consumption, mobile installation logs, calendar email address and contents, installed device profiles, profile configuration, mobile activation logs, lockdownd logs, update and restore logs, and sirianalytics (Siri activations times).

Sysdiagnose log logarchive may detail: hardware information, full name, email address, mail tokens, account phone number, Safari history, installed applications, paired/connected Bluetooth devices, BLE scans, device orientation, Maps locations, location (latitude/longitude), AirDrop logs, AirDrop phone numbers and emails, AirTag logs (#durian), and contact info (names, emails, phone numbers).

Logical acquisition through logs may be a reliable source of forensic evidence. When developing applications, developers will use one of several log functions to generate custom system logs. These logs can be monitored in real-time through the syslog streaming service (via USB or remote XPC). These logs can also be found in long term unified log storage.

The os_log, or system log, contents are stored in the logarchive. Some contents of the logarchive are temporal in nature and some will persist over a long time. Different content will have different forms of retention, some are time based and vary greatly from days to weeks to months, while others are storage size based and will be retained until the applicable storage limit has been met. The logarchive contains much of the same output as a syslog, but is stored to in files that tend to remain available for a much longer time. The logarchive is always populating its data files without any user interaction required. While the logarchive consists of many files and folders organized under a directory structure, the Finder.app program on MacOS presents the logarchive to the user as a singular file. To examine the raw contents on MacOS, a user may right click the directory and select “Show Package Contents”. The logarchive content may also be viewed with the Console.app program to show the entire log.

To parse the logarchive as one would with a conventional log file, the set of files and folders that compose the logarchive itself must be gathered and turned into a single, potentially very large, text file. This is illustrated in FIG. 7 as method 700. A complete logarchive directory will not be found on the device unless a sysdiagnose log has been generated. Sysdiagnose data acquisition is achieved by programmatically converting the /private/var/db/uuidtext directory into the logarchive directory in step 710. The logarchive is then converted, step 720, into a singular readable text file in order to parse the data.

In order to efficiently parse the data, the unified logs must be collapsed into single line messages, as represented by step 730. This allows for line-by-line examination for keywords and artifacts of interest in step 740. This may be done automatically through various programs.

After collapse, data such as notification details, communications and contacts, among other details, may be identified. For example, the Apple Push Service relays all notifications over unified logs. One of the logs available comes from the Apple Push Service Daemon (apsd) directly. This log is extremely detailed and contains all of the data required for the target application to understand where the data comes from, ensure that the target user is the correct user, determine how to present the notification, gather any images that need to be presented, and determine what to do once the user clicks on the notification. The level of data and verbosity will vary greatly depending on the target application. In some cases the application only requires a few unique identifiers, however in many cases the application requires the entire notification contents. This may be a multi-line log message which would need to be converted into a single-line log message in order to effective parse.

Some third-party applications, such as Discord, YouTube, Twitter, Instagram, and LinkedIn print the entire contents of the notification in clear text. Other applications, such as Signal and internal Apple applications, will only log a unique token without the notification text content. To find the lines from a unified log containing the notification logs, a user may search for the string “Received message for enabled topic”. This will give artifacts such as: a notification was generated at the time of this log, a notification came from the bundleID which is detailed in the log message, the notification came in when the user was connected to cellular data or when the user was not connected to cellular data, and/or the entire notification data. Similar artifacts may be gathered immediately following the prior notification data if the notification is forwarded to SpringBoard and put onto the device's screen.

Phone calls may be parsed by searching for the Call Services Daemon (callservicesd) in the log messages. This log may only contain a phone number without related contact information. Multi-line logs must be converted into single-line logs to parse this.

The call history log may be found in the unified log by searching for the Call Services Daemon (callservicesd). Call history logs may contain crucial information such as: name of caller according to the carrier, datetime of the call, duration of the call in seconds, the other device's phone number, the call status (missed call, canceled call, outgoing, incoming), if the call was blocked, if the call was auto-answered, and/or if the user saw the call. Note that this artifact is volatile and may need to be accessed through other log messages when it is no longer available.

Call history numbers may be found by the com.apple.calls.mobilephone subsystem logs. This may not be as detailed as the call history log, but can provide phone numbers that have previously appeared in the device's call log.

Contact details are logged by the instant messaging service (IMCore) when contacts or contact details are requested from an application or service. The phone numbers and emails of each contact may be logged. The most common client that logs this information is the mediaanalyisd-service, though other internal services (e.g. InCallService, siriactionsd, MobilePhone) and third-party applications with access to contacts will log the same messages. These are often multi-line messages that must be collapsed to be parsed. Assigned names, phone numbers, and email addresses of contacts are logged by the instant message shared utilities service (IMSharedUtilities) each time certain applications attempt to search for a nickname.

Called and messaged phone numbers are logged by the Real Time Text Utilities framework (RTTUtilities). This may be parsed from the log to determine that a phone number has been messaged or called, and an approximate time at which the attempted call/text was placed. However, this artifact will not provide the contents of the message.

In addition to accessing the logarchive, live monitoring to gather data may also be used. For example, the “ps” command may be used to list details about running processes. The ps command may be used in a loop while filtering the output to separate already seen processes to gain information on newly spawned processes.

The lsof command lists open files, in other words files which are currently being accessed by a process. By default, the command will detail the process reading the file, its PID, the user accessing the file, the type of file descriptor, the size of the file/node, and the name/path of the file. This command will not detail the time at which the file was opened. The lsof command may be used in a loop while filtering the output and injecting timestamps to gain information on opened files.

The syslog may be particularly important when examining malware/exploits for indicators of compromise. Most of the contents in the real-time syslog will appear in the device's collection of unified logs. Thus, most indicators of compromise obtained from this log are visible from a logical acquisition. The syslog may be gathered from a connected PC using Apple's Console application, Libimobiledevice's idevicesylog, or through other methods such as those described herein. Syslogs may also be collected directly on a mobile device through creating a fake XPC connection with oneself and initializing the collection of remote logs.

Non-volatile RAM (nvram) is a viable persistence vector on mobile devices. Changes made to nvram variables should be noted during a forensic investigation for indications of malware.

The lockdownd file (lockdownd.log) located at /private/var/logs/ or /rootfs/var/logs/ captures interactions with the lockdownd service including USB connections, USB communication, queried MobileGestalt values, XPC connections, and other XPC-related data. This file can be monitored in real-time.

The Filesystem Monitor (FSMon) program can be used to get detailed information about files, particularly when a file is modified. This program may be configured to copy files as they are modified. The monitor will pick up files as written, even if they are only saved on the device temporarily and then deleted. The device's unified logs may be rebuilt at any select point in time through manipulation of a full filesystem acquisition and files gathered by FSMon.

The KDebug subsystem may be used to log everything that happens in the kernel. Exporting this data may be done with a KDebug viewer tool with injection of Apple libraries.

What is claimed is:

1. A method for obtaining forensic data from a smartphone, the method comprising:
connecting a smartphone to a desktop computer by way of a wired connection;
determining if trust has been established between the smartphone and the desktop computer;
monitoring a system log of the smartphone to create a system log output;
filtering the system log output to create a filtered system log output; and
communicating the filtered system log output to a user interface.

2. The method of claim 1 further comprising:
receiving device information from the smartphone;
filtering the device information to create filtered device information; and
communicating the filtered device information to the user interface.

3. The method of claim 1 further comprising:
monitoring a diagnostic relay service to create a diagnostic relay service log;
filtering the diagnostic relay service log to create a filtered diagnostic relay service log; and
communicating the filtered diagnostic relay service log to a findings user interface.

4. The method of claim 1 further comprising:
monitoring a device backup service to create a device backup log;
filtering the device backup log to create a filtered device backup log; and
communicating the filtered device backup log to the user interface.

5. The method of claim 1 further comprising:
monitoring a smartphone file conduit;
obtaining a user filesystem from the file conduit;
filtering the user filesystem to create a filtered user filesystem; and
communicating the filtered user filesystem to the user interface.

6. A system for obtaining forensic data from a smartphone, the system comprising:
a system log monitor configured to receive a system log of a smartphone;
a filter; and
a user interface.

7. The system of claim 6 further comprising:
a raw output user interface configured to receive data from a diagnostic relay service; and
a findings user interface configured to receive data from the diagnostic relay service.

8. The system of claim 6 further comprising:
a device information user interface.

9. The system of claim 6 further comprising:
a user filesystem configured to receive data from a smartphone file conduit.

10. The system of claim 6 further comprising:
a device backup log configured to receive data from a smartphone backup service.
